(19) United States
(12) Patent Application Publication
(10) Pub. No.: US 2025/0262747 A1
(43) Pub. Date: Aug. 21, 2025

(54) CONTAINER

(71) Applicant: Stanley Black & Decker MEA FZE, Dubai (AE)

(72) Inventors: Shun-Chi Yang, Taichung City (TW); Wan-Chiang WANG, Taichung City (TW); Ching-Yi TU, Taichung City (TW)

(21) Appl. No.: 19/200,606

(22) Filed: May 6, 2025

Related U.S. Application Data
(63) Continuation of application No. 17/752,451, filed on May 24, 2022, now Pat. No. 12,311,527.

(30) Foreign Application Priority Data
May 24, 2021 (EP) 21175506.1

(51) Int. Cl. B25H 3/02; A47B 88/423; E05B 65/468; E05B 65/52

(52) U.S. Cl. CPC B25H 3/028; A47B 88/423; E05B 65/468; E05B 65/5253

(57) ABSTRACT

A storage container including a plurality of drawers for holding items therewithin. Each drawer may be held closed within the container by selective rotation of a detent mechanism which interacts with engagement means formed on each drawer. When the detent mechanism is in its open position, each drawer may be freely opened or closed. Whereas, when the detent mechanism is in its closed position, each drawer may be moved from an open to a closed position, but not from a closed to an open position.

### I. CROSS-REFERENCE TO RELATED APPLICATIONS

The This application is a continuation of U.S. patent application Ser. No. 17/752,451, filed on May 24, 2022, which claims priority to European Patent Application No. 21175506.1, filed on May 24, 2021. The entire content of the foregoing patent applications is incorporated herein by reference, including all text, tables and drawings.

### II. FIELD OF THE INVENTION

The present invention relates to containers which include a plurality of storage sections, such as drawers, each of which may be opened or closed. When a storage section is closed, its inside (and, hence the contents thereof) is inaccessible to a user of the container. Whereas, when the storage section is open, a user may access the inside thereof. The present invention has particular, although not exclusive, relevance to such containers as are used for holding and transporting tools and the like.

### III. BACKGROUND OF THE INVENTION

Retention and transportation of tools within a container is a common requirement for tradespeople, who have to be able to transport their tools from one worksite to another, or to be able to store the tools securely within the container. Because such a tradesperson may need regular and frequent access to their tools when working on a jobsite, the ease with which a tool may be removed and then replaced within the container becomes an important issue. A time-consuming process to open and/or securely close a storage section of the container may take up too much valuable time.

Whilst the provision of the ability to lock a storage section in either its open or closed position may be an attractive proposition, as a practical matter, ease of access and speed of opening and closing the storage section is equally important. The ability to lock a storage section in its closed position can be a requirement either as a default position (to prevent inadvertent opening of the storage section, which could cause the contents thereof to be spilled), or as an optional feature to be employed when the container is being transported, for example, from one jobsite to another.

Containers employing lockable storage sections are known. Examples include U.S. Pat. No. 9,901,170 which discloses a cabinet including a plurality of slidable drawers. Each draw can be individually locked (to prevent opening) or unlocked (to permit opening).

U.S. Pat. No. 7,832,584 shows a tool chest having a plurality of drawers which can all be locked by hinged doors to prevent the drawers from sliding open when the chest is being transported from site to site.

There exists a problem with such known lockable containers, however. In order for a user to be able to close the storage section, they need to perform the task of unlocking the storage sections against their movement restraint. This might seem a trivial task, but it takes time and the cumulative effect of repeating this operation over the course of a day' s work can become quite time-consuming.

It would be desirable or an object of the present invention, therefore, to provide a container to overcome existing problems of known lockable containers.

### IV. SUMMARY OF THE INVENTION

Some preferred or advantageous features of the present invention are found in the claims.

By provision of a detent mechanism which permits selective interaction with the engagement means of each storage means such that the storage means is able to be moved from its open position to its closed position even if/when the detent mechanism is arranged to restrain each storage section in its respective closed position, the present invention provides a more versatile container than has hitherto been available. In particular, this enables a user of the container to simply and quickly close an open storage section, even when the container is in its locked/closed state (ie drawers to be prevented from being opened).

According to a further object of the invention, there is provided a container comprising: a housing defining a drawer opening and lock opening; a plurality of drawers disposed in the drawer opening and wherein each of said drawers is configured to move between an open and closed position, wherein in said open position, access to an interior of the drawer is uninhibited, and in said closed position, access to the interior of the drawer is inhibited; a rotating lock disposed in the lock opening and having a series of cams and flats, and wherein said rotating lock is configured to rotate between a locked position and an unlocked position, wherein in said locked position, a cam prevents a drawer from moving from its closed position to its open position, and wherein in said unlocked position a flat permits a drawer may move freely between its open and closed position; and characterized in that each of the drawers includes a stop having a ramped surface and a locking surface, and wherein the ramped surface is configured engage a cam and permit a drawer to move from its open position to its closed position, when the rotating lock is in its locked position, and wherein the stop is configured to engage a cam and prevent a drawer from moving from its closed position to its open position when the rotating lock is in its locked position.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### V. DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1 shows a perspective view of a container in accordance with the present invention;

FIG. 2 shows a perspective view of the container of FIG. 1 with the detent mechanism in its locked position;

FIG. 3 shows a perspective view of the container of FIG. 1 with the detent mechanism in its unlocked position;

FIG. 4 shows two perspective views (each rotated through 180° with respect to the other) of the detent mechanism;

FIG. 5 shows an exploded perspective view of the major components of the container of FIG. 1;

FIG. 6 shows a sectional view a drawer of the container of FIG. 1, along the line X-X;

FIG. 7 shows a detailed sectional view of the area A of FIG. 6;

FIG. 8 shows a perspective view of one of the drawers;

FIG. 9 shows a detailed perspective view of part of the drawer of FIG. 8;

FIG. 10 shows a perspective view of the inside of the container of FIG. 1, with all drawers removed;

FIG. 11a shows a plan view from above of the container of FIG. 1 with the lock in its locked position;

FIG. 11b shows a partially-sectioned front view of FIG. 11a;

FIG. 11c shows a partially-sectioned perspective view of the container of FIGS. 11a and 11b;

FIG. 11d shows a schematic section of the interaction between the lock and the drawer of FIGS. 11a, 11b and 11c;

FIG. 12a shows a plan view from above of the container of FIG. 1 with the lock in its unlocked position;

FIG. 12b shows a partially-sectioned front view of FIG. 12a;

FIG. 12c shows a partially-sectioned perspective view of the container of FIGS. 12a and 12b;

FIG. 12d shows a schematic section of the interaction between the lock and the drawer of FIGS. 12a, 12b and 12c.

FIG. 13a shows a side perspective view from above of a container according to a second embodiment of the present invention;

FIG. 13b shows, in detail, the area A of FIG. 13a;

FIG. 14a shows a side perspective view of the container of FIG. 13a;

FIG. 14b shows, in detail, the area B of FIG. 14a;

FIG. 15a shows a side perspective view from above of the container of FIG. 13a;

FIG. 15b shows, in detail, the area C of FIG. 15a;

FIG. 16 shows a plan view from above of the container of FIG. 13, with its drawer in the open position;

FIG. 17a shows a part-sectional view, of the rotatable lock of FIG. 16;

FIG. 17 b shows a detailed view of the circled section of the rotatable lock of FIG. 17a;

FIG. 18a shows a part-sectional view, of the rotatable lock of FIG. 16, when the drawer has started to move from its open towards its closed position;

FIG. 18b shows a detailed view of the circled section of the position of the rotatable lock of FIG. 18a;

FIG. 19a shows a part-sectional view, of the rotatable lock of FIG. 16, when the drawer has moved to its closed position;

FIG. 19b shows a detailed view of the circled section of the position of the rotatable lock of FIG. 19a.

FIG. 20a shows a part-sectional view, of the rotatable lock of FIG. 16, when the drawer has moved to its closed position and the rotatable lock has been moved into its unlocked position;

FIG. 20b shows a detailed view of the circled section of the position of the rotatable lock of FIG. 20a.

Corresponding illustrated images and attachments indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### VI. DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

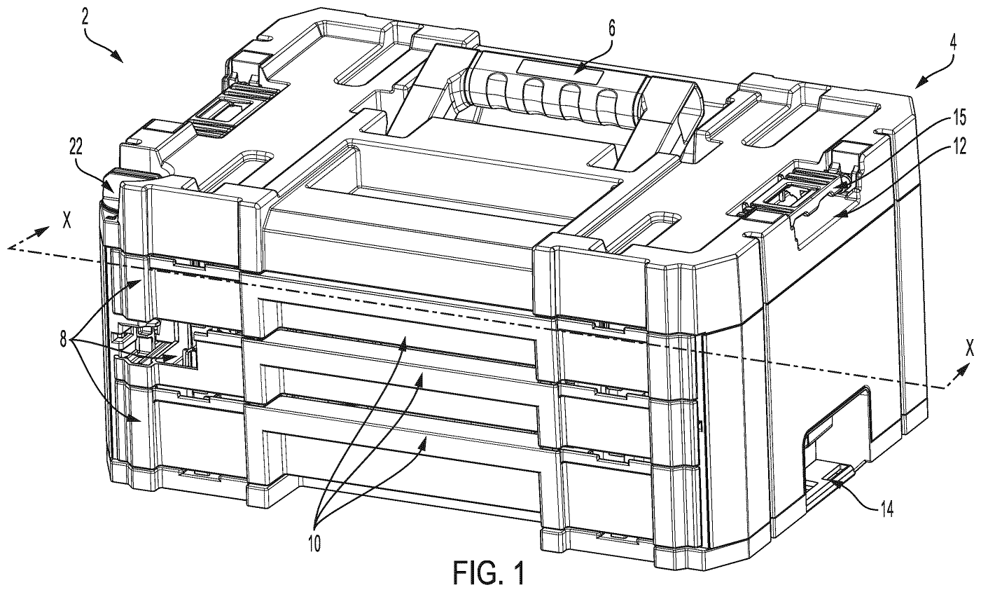

Referring firstly to FIG. 1, it can be seen that a container 2 comprises a plastics body 4 having a carrying handle 6 and a plurality (here three) of storage sections, here slidable drawers 8. Each of the drawers 8 can be moved either completely into the body 4 of the container 2 (i.e. into its “closed” position), or out (even partially) of the body 4 (i.e. into its “open” position), independently of any or all of the other drawers. To effect opening or closing of the drawers, each of them is formed with a front handle 10 which can be grasped by a user to move the drawer 8.

The container 2 includes upper 12 and lower 14 locators such that stacking of containers upon each other is possible. The upper and lower locators 12, 14 are lockable to each other via user-moveable latch means 15. The possible stacking of the containers 4 will not be described further herein, as this concept is well-known to those skilled in the art.

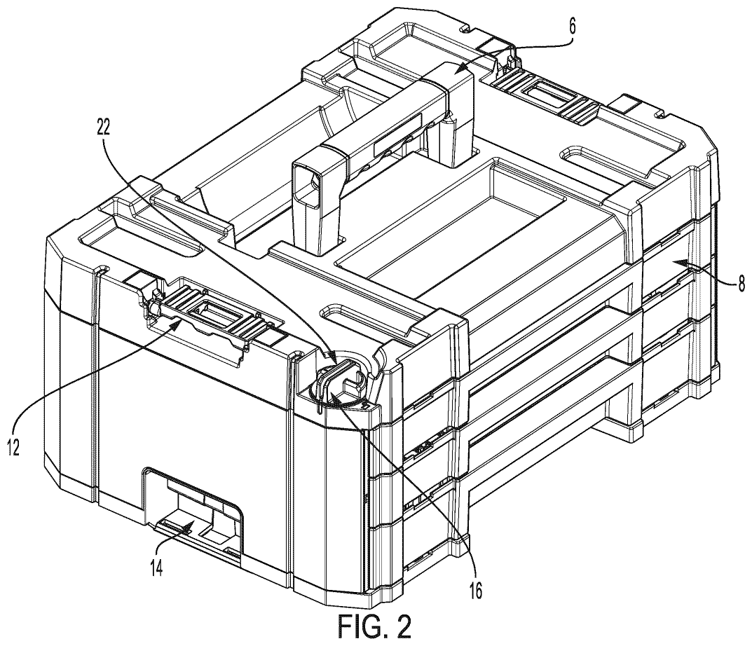

The container 2 includes a detent mechanism, here a rotatable lock 16. Reference to FIG. 2 shows the lock 16 positioned at one corner of the container. The lock 16, in this example, is manually-rotatable permitting a user of the container to move the detent mechanism between and to its “locked” or “unlocked” positions by a go0 rotation of the lock 16, as will be described in more detail below. When the rotatable lock 16 is in its locked position, any (or each, or all) of the drawers 8 which are in their closed positions within the container 2 are unable to be opened. Whereas, when any (or each, or all) of the drawers 8 is in its open position, it can be moved by a user into its closed position-ie moved to be within the container 2. When the rotatable lock 16 is in its unlocked position, any (or each, or all) of the drawers 8 which are in their closed positions within the container 2 are able to be opened and any (or each, or all) drawers 8 which are in their open positions (ie outside—either partially, or fully) the container 2 are able to be closed. In other words, when the rotatable lock 16 is in its unlocked position, all of the drawers 8 have free movement between their open and closed positions.

In FIG. 2, the lock 16 is in its locked position, meaning that, as all the drawers 8 are closed and held within the container 2, then access to the insides of each drawer 8 is not possible. With the lock 16 in its locked position, all drawers 8 as shown in FIG. 2 which are closed are unable to be opened.

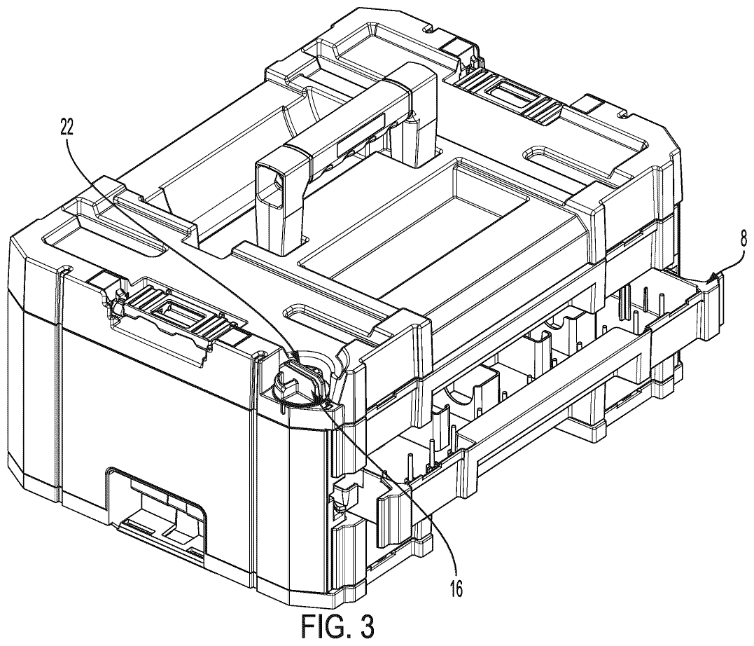

FIG. 3 shows the lock 16 having been rotated by go0 as compared to its position in FIG. 2, such that it is in its unlocked position, which permits any one, or ones, of the drawers 8 to be moved into its open position. In the figure, only the middle drawer 8 has been opened and only partially.

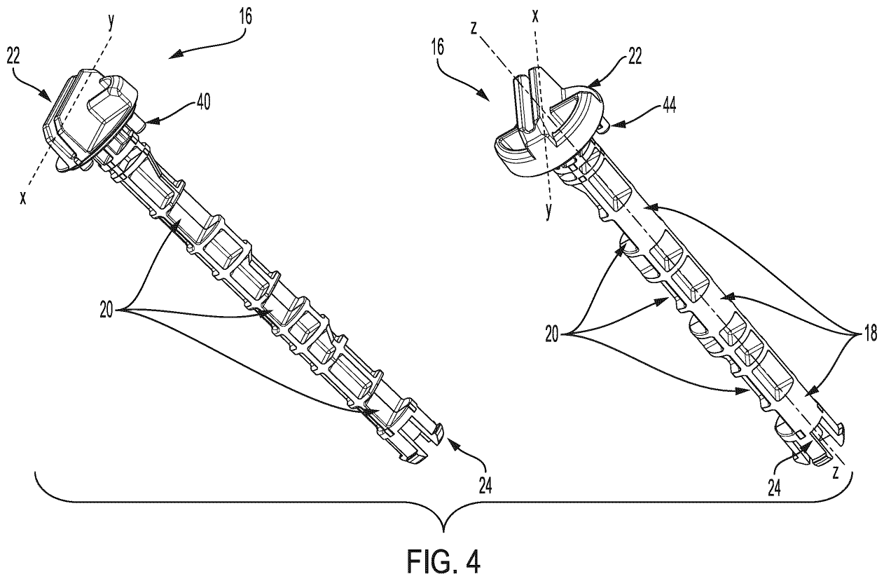

Reference to FIGS. 4a and 4b show the lock 16 in two perspective views, where the lock 16 has been rotated through 180° as between FIGS. 4a and FIG. 4b. It can be seen that the lock 16 has a series of alternating cams 18 and flats 20 extending axially along its major axis, z-z. The purpose of these cams 18 and flats 20 will be explained below.

At one end of the lock 16 is formed a manually-actuable knob 22 and at the other end a snap-fit retainer 24 to hold the lock 16 in place when inserted into the container 2. The lock 16 is generally circular in cross-section and extends along a major axis, z-z (see FIG. 4b). The lock is rotatable about this axis such that a user may grasp the knob 22 to affect rotation of the lock 16.

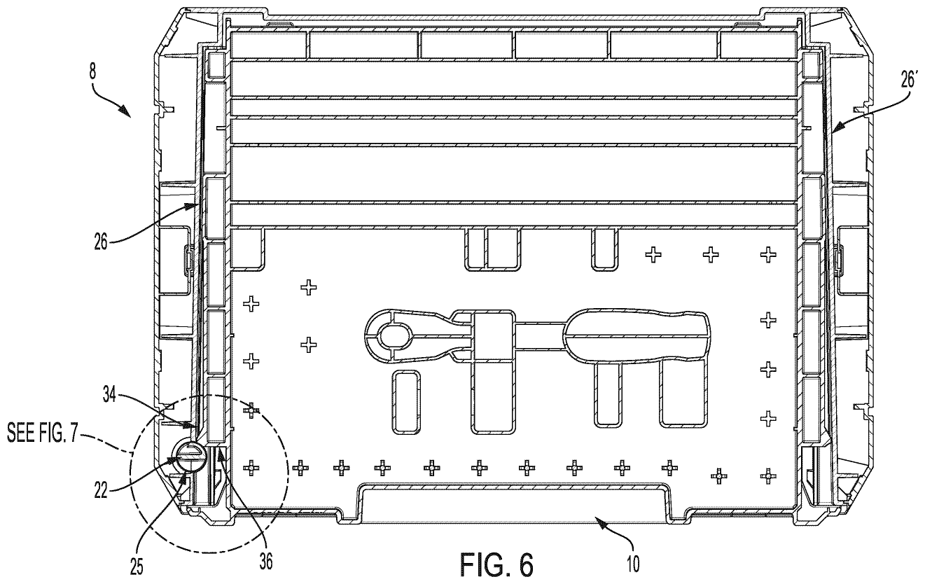

FIG. 6 illustrates how the lock 16 fits into an axial channel 25 formed in the body of the container 2. Once held within the channel 25 by cooperation between the body of the container 2 and the snap-fit retainer 24, the lock 16 may be rotated about its axis z-z by a user exerting torque on the knob 22. The lock is able to rotate +/−90°, as will be explained below.

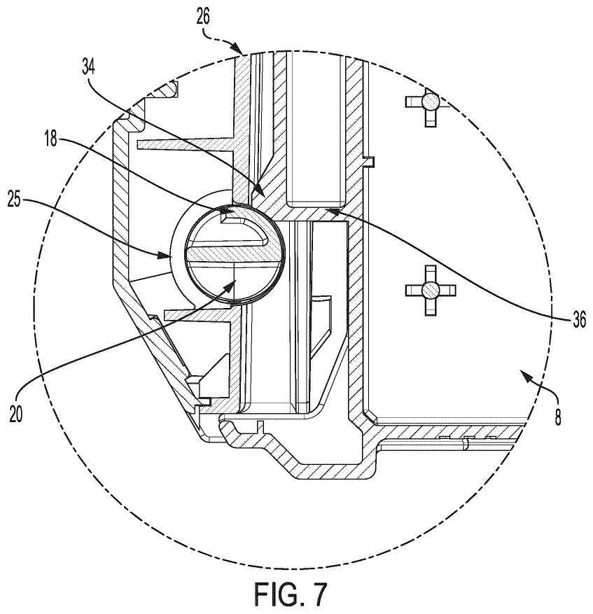

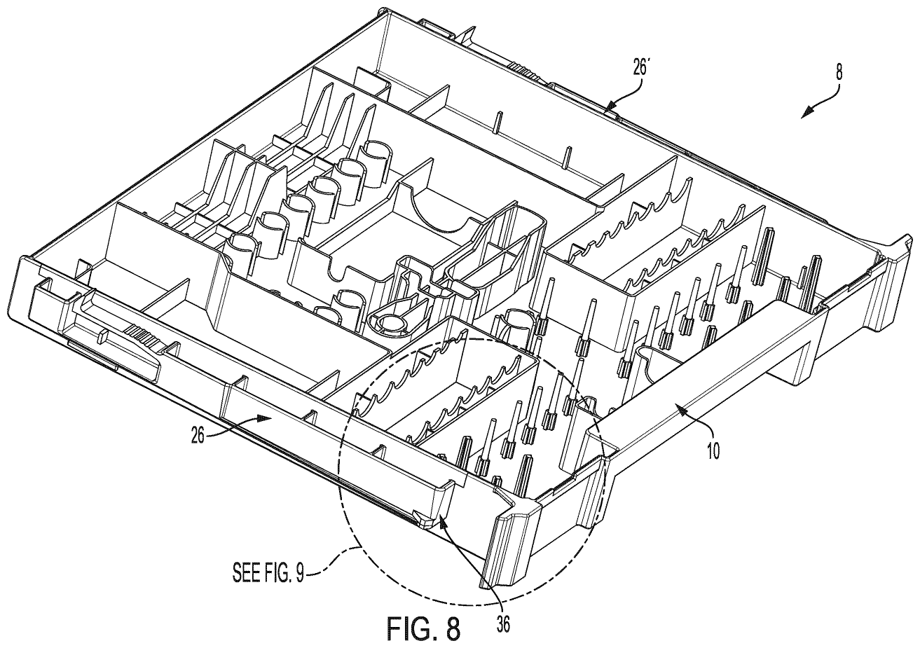

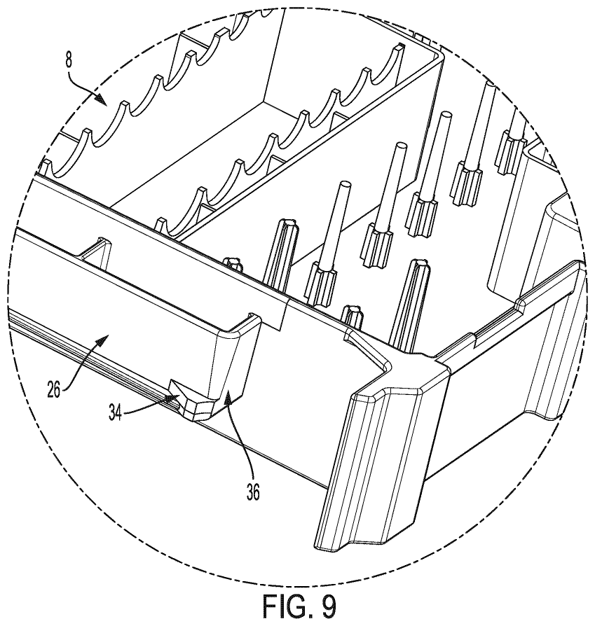

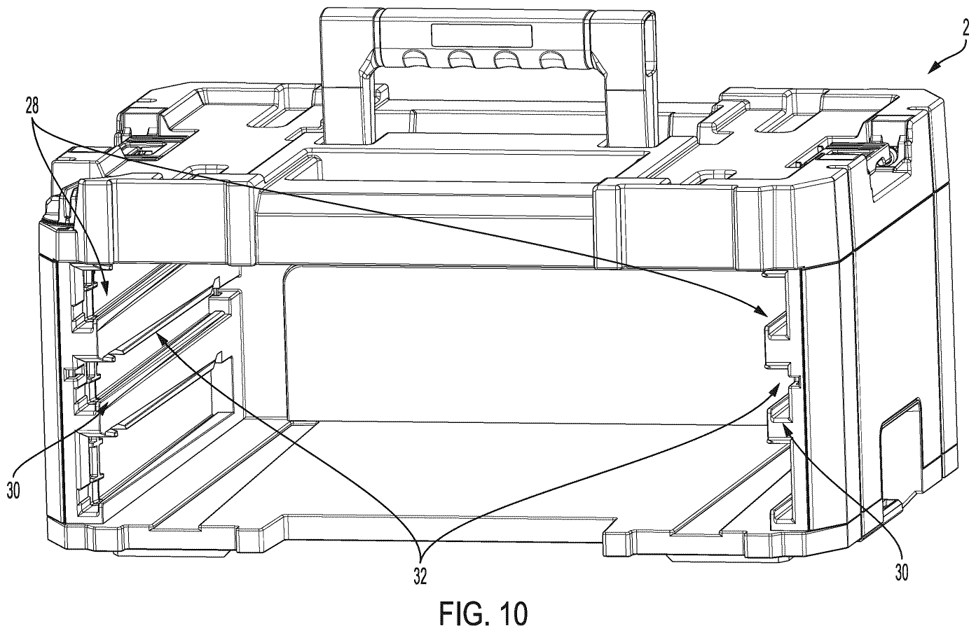

Referring now to FIGS. 7, 8, 9 and 10, it can be seen that a representative drawer 8 includes, in this example, its integral handle 10 with which a user of the container 2 may open and close the drawer 8. The drawer 8 is bounded (at its left-hand side as viewed at FIG. 8) by an engagement bar 26, which co-operates with a pair of container runners 28, 30 (see FIG. 10) in order to retain the drawer 8 in the container 2 and permit it to be opened and closed along internal container drawer slot 32. It will be appreciated that a similar engagement bar 26′ is formed at the right-hand side of each drawer.

At the forward outside edge of the engagement bar 26 is formed an engagement means, in this example wedge 34. The purpose of the wedge 34 is to selectably co-operate with the rotatable lock 16, as will be explained. In this example, the co-operation is between the wedge 34 and the cams 18 and flats 20 of the rotatable lock 16.

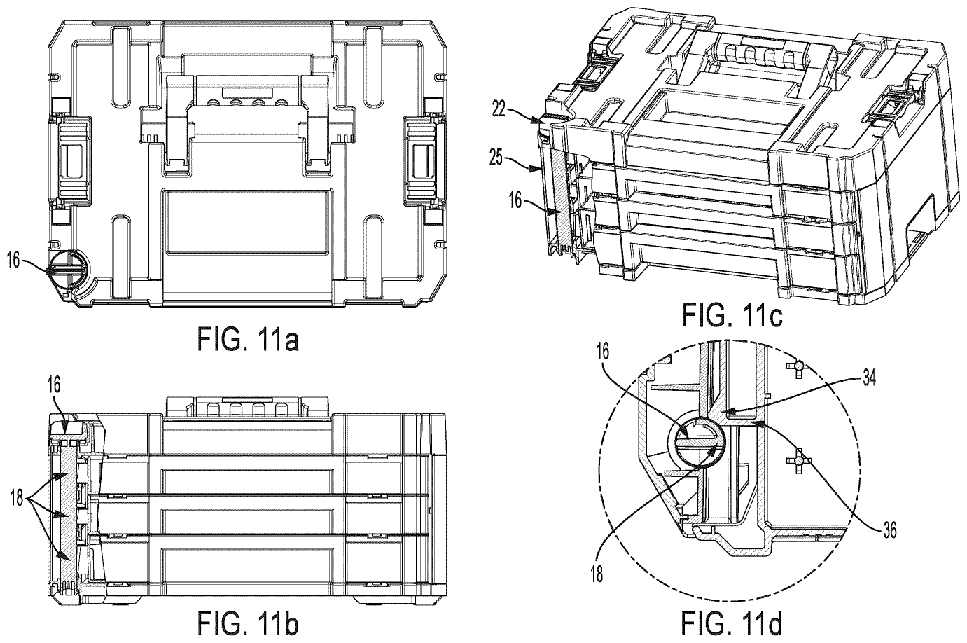

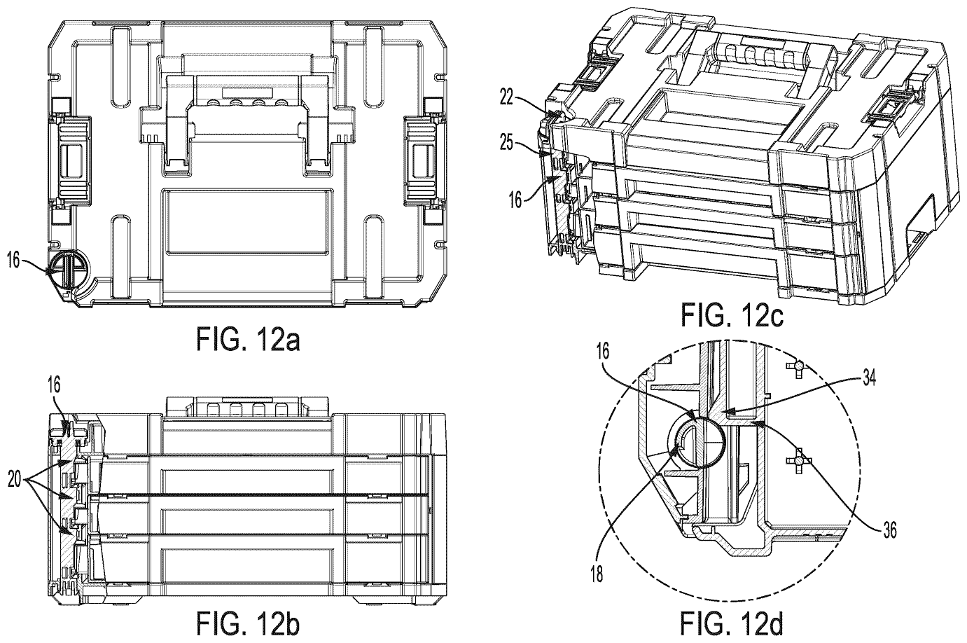

In order to understand the interaction between the rotatable lock 16 and wedge 34, reference is made to FIGS. 11a, 11b, 11c and 11d, which all show the rotatable lock 16 in its locked position. In the locked position, the lock 16 prevents any opening from its closed position within the container 2 (either partial or full) of each drawer 8. However, in the unlocked position, if any one, ones, or all of the drawers 8 are open (either partially or fully), they may each be moved into their respective closed positions within the container. FIGS. 12a, 12b, 12c and 12d show the lock 16 in its unlocked position.

In FIGS. 11a-11d it can be seen that the knob 22 has been rotated such that each cam 18 of the rotatable lock 16 projects into the path of the drawer 8 such that the wedge 34 of the drawer 8 cannot be moved past the cam if and when a user makes any attempt to open the drawer from its closed (ie captive within the container 2) position to its open position. It is, therefore, not possible for the drawer 8 to be moved into its open position from being within the container 2 by being pulled via its handle 10 along the drawer slot 32. This is due to the interaction between the wedge 34 and the cam 18, here the abutting of the front outer surface 36 of the wedge 34 against the cam 18. This interaction may also be seen in FIG. 7. The cam 18 presents a physical barrier to the opening of the drawer 8 due to the contact between it and the front outer surface 36 of wedge 34.

As has been described above, the rotatable lock 16 comprises an axially-extending series of cams 18 and flats 20 (in this example 3 of each). FIGS. 11band 11d show how the series of cams 18 present a physical block to the passage therepast of each respective drawer 8. Comparing these figures to their equivalent FIGS. 12b and 12d, however, in which the rotatable lock 16 has been rotated through 90°, shows how the flats 20 do not present a barrier to the opening (or, indeed any movement, be that opening or closing) of the respective drawers 8.

Hence, when the rotatable lock 16 has been rotated (via knob 22) into the position shown in FIGS. 12, the user of the container 2 is able, via the handle 10, to freely move each and all drawers 8 between their open and closed positions. This is because there is no cam 18 to restrain the movement of the drawer 8 by engagement with the front outer surface 36.

An important feature of the present invention is the wedge 34 which formed on each drawer 8. As the drawers 8 are arranged (via their upper and lower runners 28, 30) to be able to slide into and out of their respective drawer slots 32 (only one of which is shown, for clarity, at FIG. 10), each wedge 34 is shaped so as to permit closure of a drawer 8, even if the rotatable lock 16 has been rotated into its locked position. The reason this is possible is that the material from which the wedge 34 is formed is chosen to be resiliently deformable. An example of such material is a rubber compound. This means it is compressible, as the wedge is forced into engagement with the cam 18 as the drawer 8 is moved from its open to its closed position and when the rotatable lock is in its locked position (FIG. 7 and FIG. 11d). There is a ramping effect as the narrow part of the wedge first contacts the cam 18, which effect increases in force (a compression force applied to the material of the wedge) as the drawer 8 is further closed. Eventually, if sufficient closure force is applied to the drawer 8 via its handle 10 by a user, then the entire wedge 34 is compressed sufficiently to be forced past the cam 18 until the final position is achieved as shown in FIGS. 7 and 11d. In this final (closed) position, the wedge has taken up its original shape, having moved completely past the cam 18.

It will be appreciated that, as an alternative to the material of the wedge 34 being resiliently deformable, it is also possible for the engagement bar 26 and/or the outer front surface 36 of wedge 34 to be resiliently deformable, so that, as the wedge 34 is moved past the cam 18 (ie when the drawer 8 being moved from its open to its closed position), the increasing force placed upon the wedge 34/engagement bar 26 interface as a result of the drawer 8 movement, causes flexing and deformation of the engagement bar 26 to (as would be the case when viewing FIG. 7) the right, so that passage of the wedge 34 past the cam 18, whilst being in contact therewith, is possible. The same effect could be achieved (as an alternative to resilient deformation of the engagement bar 26, or in addition thereto) by the outer front surface 36 being compressible such that it can be shortened (again, in the direction towards the right as shown in FIG. 7) as the wedge 34 moves pat and in contact with the cam 18.

Importantly, due to the shape of the wedge 34 and the presentation of the outer front surface 36 to the cam 18, subsequent opening of the drawer is not possible unless and until the rotatable lock 16 is rotated through 90° into its open position, shown in FIGS. 12, where a flat 20, as opposed to a cam 18 is opposite the outer front surface 36 of wedge 34.

Those skilled in the art will appreciate that the wedge 34 could be made from a non-resilient material. In this case, the cam 18 and/or the engagement bar 26 would need to be resilient and, preferably, made of a resiliently deformable material. The important requirement here is that there is the ability for the wedge 34 to move past the cam 18 when both i) the rotatable lock 16 is in its locked position and ii) the drawer 8 is open and desired to be closed; such that the drawer 8 can be moved (under force) past the cam 18 from its open to its closed position.

From the foregoing, it will be appreciated that by rotating the knob 22 between its two 90° spaced-apart positions, then selective alignment between either i) the cams 18, or ii) the flats 20 with the wedge 34 of each respective drawer 8 occurs. FIG. 11d shows the alignment of the cam 18 with the wedge 34 (ie the rotatable lock 16 is in its locked position) and FIG. 12d shows alignment of the flat 20 with the wedge 34 (ie the rotatable lock 16 is in its unlocked position). In the unlocked position of FIG. 12, there is no interaction between the flats 20 and wedges 34. This permits free movement of each drawer 8 between its open and closed positions.

When a drawer 8 is in its closed position, it is retained completely within the body of the container 2, as shown, for example in FIG. 2. When a drawer is closed like this, access to the inside of the drawer and hence its contents, is not possible.

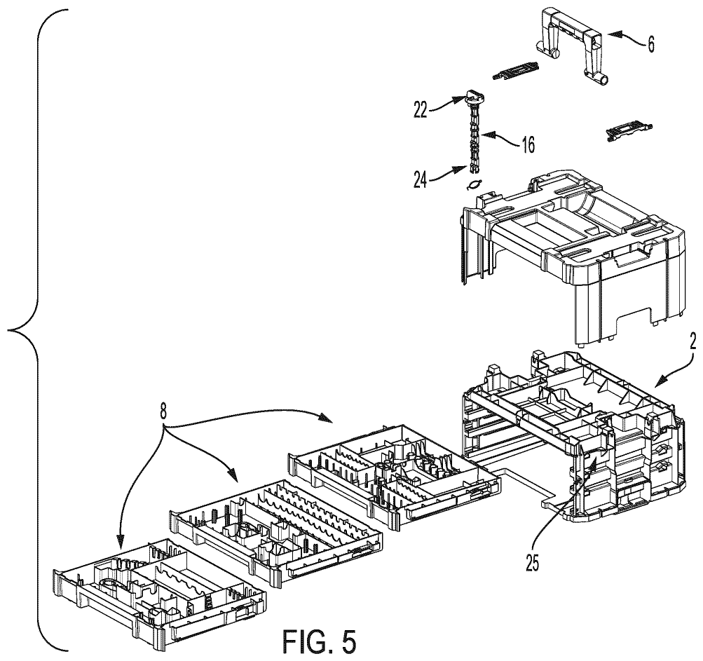

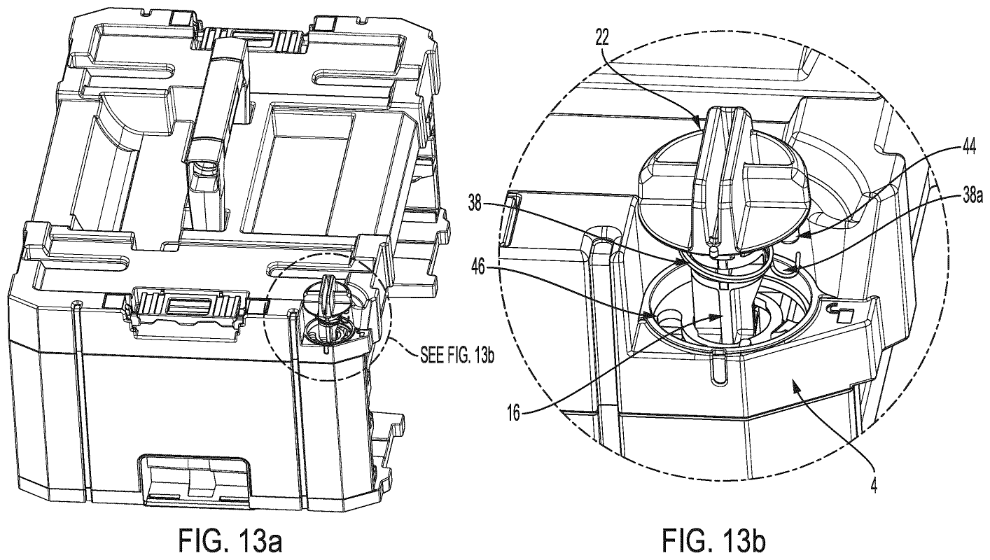

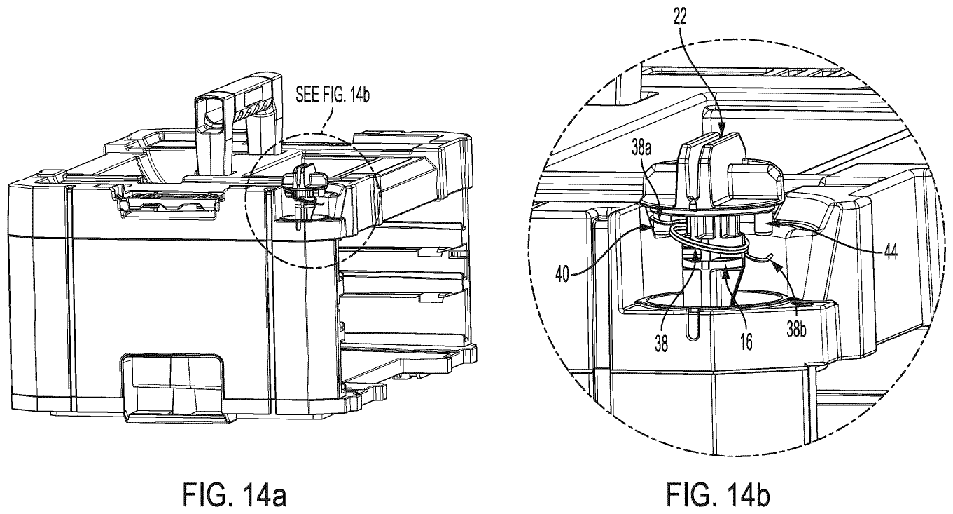

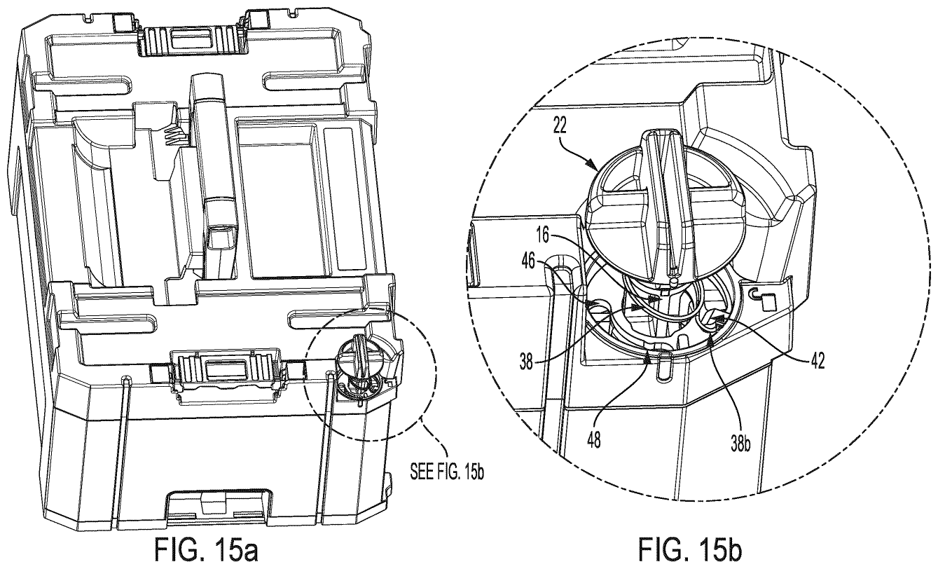

Referring now to FIGS. 13-20, an alternative embodiment to that of FIGS. 1-12 is shown, although common components are labelled with the same reference numerals as per the earlier figures. Whilst the embodiment of FIGS. 13-20 also utilizes the drawer wedge 34, it operates in a slightly different manner in its interaction with the rotatable lock 16, as will be explained.

In FIG. 13-20, the rotatable lock 16 is spring-biased towards its locked position, with the ability for it to be rotated and held in its unlocked position. To achieve this a spring member 38 engages with the rotatable lock 16 and the plastics body 4 of container 2 so as to provide a torsion force therebetween. The rotatable lock 16 will always tend to rotate from its unlocked to its locked position in the alternative embodiment of FIGS. 13-20, unless it has been held or restrained in its unlocked position and is, therefore, unable to rotate. It is in this instance that deflection of the wedge 34 past the cam 18 (rather than the rotatable lock being rotated into its unlocked position) occurs. In particular, when the rotatable lock 16 is in its locked position and a drawer 8 is in its open position, movement of the drawer into its closed position will either cause the wedge 34 of the drawer 8 to resiliently deflect past the respective cam 18 of the rotatable lock 16 (as in the previous embodiment of FIGS. 1-12), or cause the rotatable lock 16 to rotate from its locked to its unlocked position (in either case, permitting closing of the drawer 8).

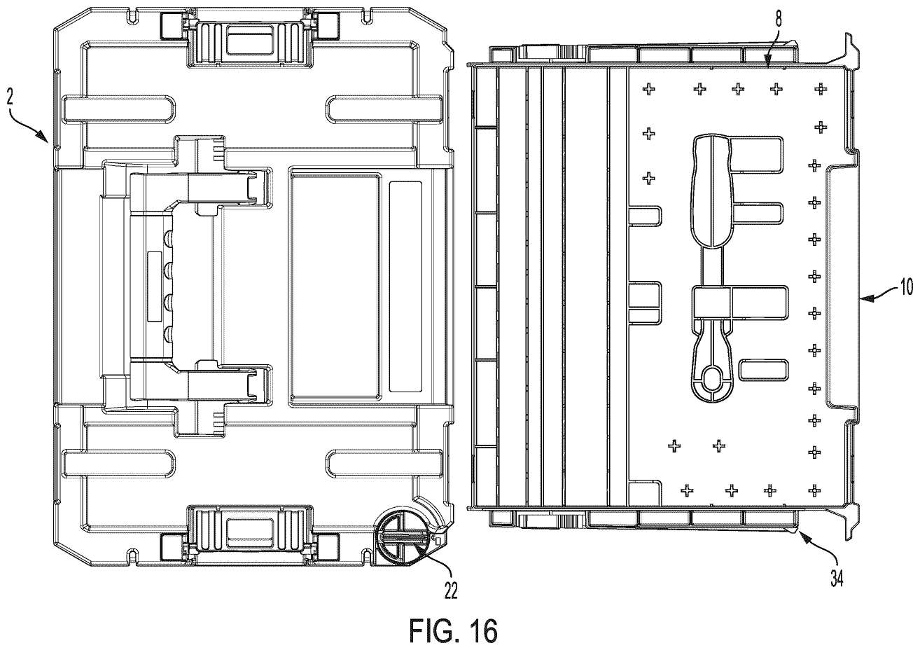

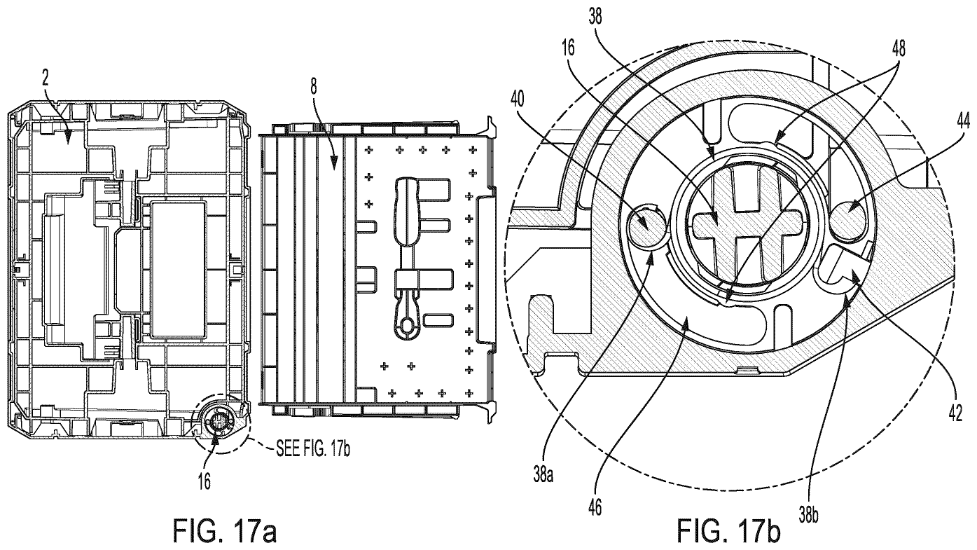

Referring now particularly to FIGS. 16-20, the sequence of moving a drawer from its open to its closed position, when the rotatable lock is initially in its locked position, is shown. In FIGS. 16 and 17, the rotatable lock 16 is in its locked position. This is its normally biased position as result of the force of spring 38 being held under tension and applying torque thereto (in a clockwise sense as viewing the figures). The spring member 38, which has one end 38a coupled to knob 22 spigot 40 and its other end 38b coupled to container spigot 42, is placed under tension, in known manner.

The underside of knob 22 carries two spigots; the first spigot, 40 engages with the end 38a of the spring 38. Both the first and second knob spigots 40, 44 respectively are arranged to travel within arcuate slot 46 formed in the body of the container 2 as the rotatable lock 16 rotates.

The rotatable lock 16 may be held in its unlocked position as result of the interaction between the spigots 40, 44 and two diametrically-opposed arcuate lands 48 formed on the inner surface of arcuate slot 46. If the knob 22 (or indeed the rotatable lock 16) is rotated anti-clockwise (as the figures are viewed) with sufficient force that each spigot 40, 44 is able to move past and over its respective land 48, then, on removal of that rotational force, the interaction of the lands 48 with the spigots 40, 40 holds the spigots in place (ie in its unlocked position). Unless sufficient force in a clockwise sense is applied to the rotatable lock 16, the spigots 40, 44 are unable to ramp over the lands 48 to return the rotatable lock 16 to its normally locked position.

In its locked state, the rotatable lock 16 presents its cam 18 to the drawer wedge 34. In its unlocked state, the rotatable lock 16 presents its flat 20 to the drawer wedge 34.

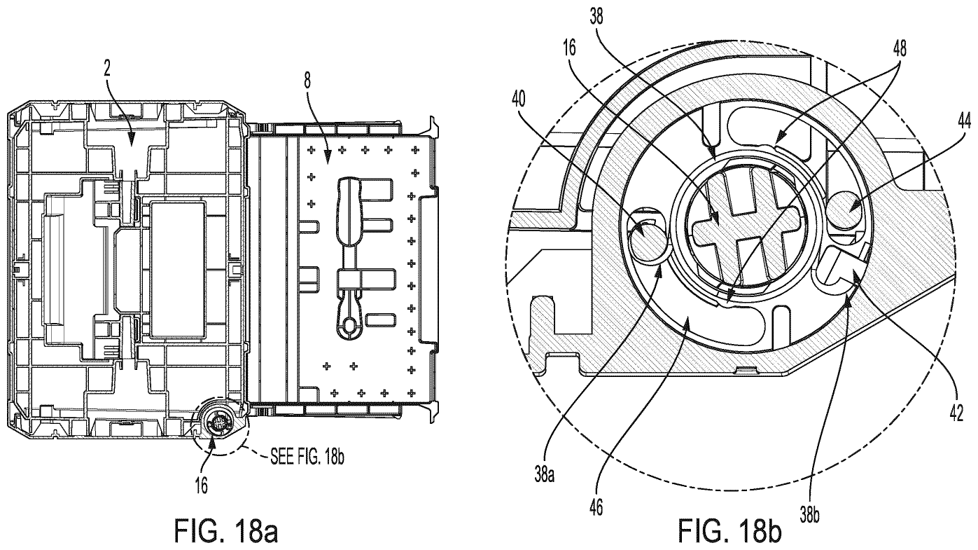

Movement of the drawer 8 towards its closed position, as shown in FIG. 18a causes the wedge 34 to push against the cam 18 and hence apply torque (anti-clockwise as viewing FIG. 18b) to the rotatable lock 16. This causes the spigots 40, 44 to move anti-clockwise away from their locked position and travel within slot 46 towards their respective lands 48, hence, causing partial rotation of the rotatable lock 16, as shown in FIGS. 18a and 18b.

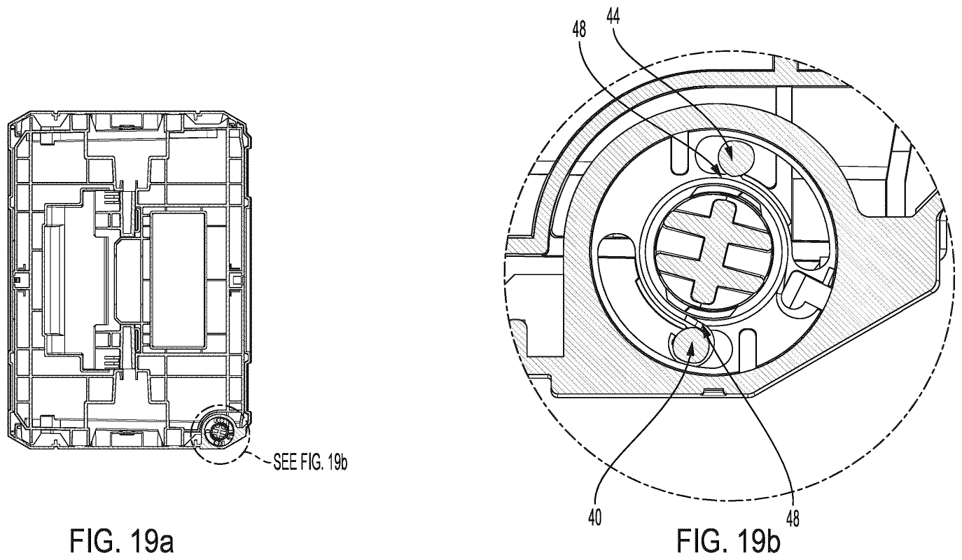

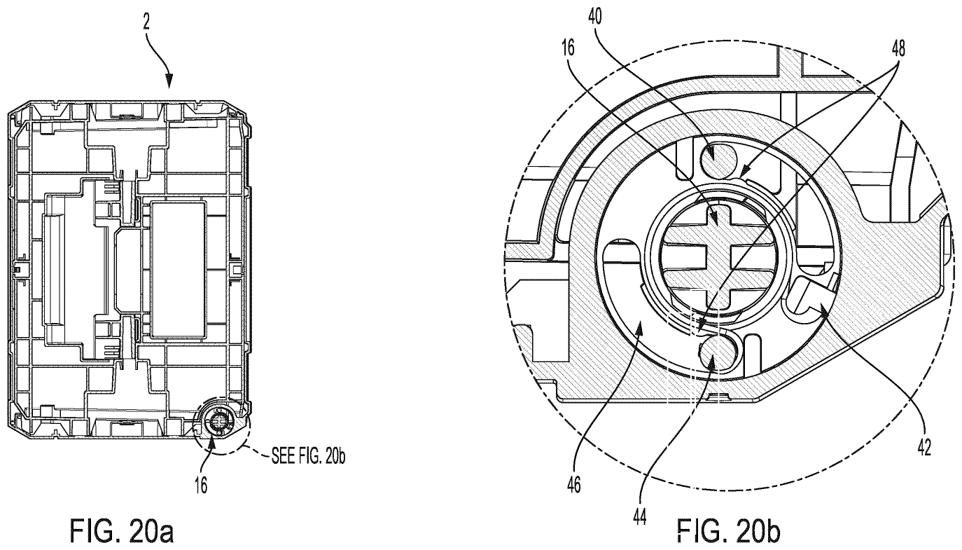

Continued closing of the drawer 8 results in the situation shown in FIGS. 19a and 19b. In FIG. 19b, the rotatable lock 16 has been moved into its unlocked position and hence the drawer has been closed. Importantly, it can be seen from FIG. 19b that the spigots 40, 44 are abutting against, but have not been moved (anti-clockwise) past their respective lands 48. This means that as soon as the wedge 34 of drawer 8 has moved past the cam 18 of rotatable lock 16, then (unless the knob 22 is either held fast, or rotated further anticlockwise by a user such that the spigots do move over and past their respective lands 48) the rotatable lock 16, under the action of the spring 38 tension, will rotate clockwise back into its unlocked position (as shown, for example, in FIG. 17b). This means, therefore, unless a user rotates knob 22 such that the rotatable lock is moved into its unlocked position as shown in FIGS. 20a and 20b, where the spigots 40, 44 are retained in slot 46 by their respective lands 48 (having been moved over and past the lands 48), then the drawer 8 is now retained in its closed position within container 2, as the rotatable lock has automatically sprung back under the action of spring 38 to its normally locked state.

FIGS. 20a and 20b show the situation where a user has rotated knob 22 such that the rotatable lock is held in its unlocked position.

Although the described detent provides physical contact between the engagement means of the storage sections and the detent mechanisms, as described above, other detent mechanisms are within the scope of the invention, such as magnetic switched lock elements. Such a magnetic lock would have magnets (such as an electromagnet) on the rotatable lock and/or each drawer. The electromagnet can be selectably activated (locked) or de-activated (unlocked) to allow the retention (locked) of each drawer in its closed position (and to be able to move from its open to its closed position), or to prevent opening of the drawer (locked)

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

1-12. (canceled)

13. A stackable container comprising:
a plastic body, the body having a channel;
a carrying handle coupled to the plastic body;
at least two locators configured to position and secure another container above or below the stackable container;
a plurality of storage sections, each storage section of the plurality for containing items therein, each of the storage sections of the plurality being movable along a passage between an open position and a closed position independently of the other of the storage sections of the plurality,
wherein, in the open position, items within the storage sections are accessible, and when in the closed position, items within the storage sections are inaccessible; and
a lock body, the lock body disposed within the channel and movable between locked and unlocked states, wherein the lock body includes a plurality of stop surfaces, each stop surface is configured to present a physical block along the passages when the lock body is in the locked state, wherein moving the lock body from a locked state to an unlocked state moves the stop surface out of the passages so as to remove the physical block from the passages,
wherein, when the lock body is in its locked state, any storage section in its closed position is locked in the closed position by the associated stop surface and any storage section in its open position may be moved to its closed position,
wherein, when the lock body is in its unlocked state, each respective storage section may be moved freely between its open and closed positions.

14. The stackable container of claim 13, wherein the lock body comprises an integrally formed manually-actuable portion, wherein the manually-actuable portion is directly accessible to a user from outside the plastic body for moving the lock body between the locked state and the unlocked state.

15. The stackable container of claim 13, wherein each storage section comprises a wedge, wherein the wedge is configured to engage with the lock body to permit the respective storage section to be moved from the open position to the closed position when the lock body is in the locked state.

16. The stackable container of claim 15, wherein the wedge comprises a front outer surface, wherein engagement of the front outer surface with the stop surface restrains the respective storage section in its closed position.

17. The stackable container of claim 13, wherein the plastic body comprises opposing slots for each storage section, the opposing slots having surfaces adjacent to the respective storage section, wherein when the lock body is in the locked state, the associated stop surfaces project within at least one of the opposing slots, and when the lock body is in the unlocked state, the associated stop surfaces do not project within the opposing slots.

18. The stackable container of claim 13, wherein the at least two locators include two upper locators and two lower locators.

19. The stackable container of claim 18, wherein the channel is disposed in front of one upper locator and lower bottom locator.

20. The stackable container of claim 18, wherein the plastic body comprises an outer cover, wherein the carrying handle and two top locators are coupled to the outer cover.

21. The stackable container of claim 18, wherein the two upper locators and the two lower locators are lockable to a respective two lower locators and two upper locators on another container.

22. The stackable container of claim 18, wherein the two lower locators are integrally formed with the plastic body.

23. The stackable container of claim 18, wherein each of the at least two locators are configured to lock the other container to the plastic body.

24. The stackable container of claim 13, wherein the channel is an elongate channel defined by the plastic body, and the lock body is an elongate lock body longitudinally extending within the channel.
